(19) United States
(12) Patent Application Publication
(10) Pub. No.: US 2016/0107275 A1
(43) Pub. Date: Apr. 21, 2016

(54) CUTTING BLADES AND METHODS OF MANUFACTURING SAME

(71) Applicant: B E 4 S.R.L., Travagliato, BRESCIA (IT)

(72) Inventor: Luca Mussio, Travagliato, BRESCIA (IT)

(21) Appl. No.: 14/892,592

(22) PCT Filed: May 19, 2014
(86) PCT No.: PCT/IB2014/061533

§ 371 Date: Nov. 20, 2015

(30) Foreign Application Priority Data
May 21, 2013 (IT) BS2013A000073

(51) Int. Cl. B23P 15/28; C25D 11/16; B24B 3/36

(52) U.S. Cl. CPC B23P 15/28; B24B 3/36; C25D 11/16

(57) ABSTRACT

Methods of making cutting blades in aluminium or its alloys are provided. The methods include the steps of making a sheet in aluminium or its alloys having the shape of the desired cutting blade, performing a sharpening operation of the blade, subjecting the blade to an anodising process, so as to form at least on the portion of the sharpened blade a layer of aluminium oxide (Al₂O₃). The sharpening operation includes laying the sheet on a planar support surface and causing a sharp cutter for aluminium advance along the peripheral edge of an outer portion of the sheet surface opposite the support surface suitable for reducing the thickness of said edge according to a predefined angle of sharpening so as to obtain a cutting edge by removal of the shaving. Cutting blades are also provided.

The present invention relates to a method of manufacturing a cutting blade, for example a knife.

As is known, cutting blades are generally made of steel or, although less widespread, of ceramic. Steel blades have a good cutting quality, are easily re-sharpened when they lose their edge, are very robust and generally have limited costs. However, especially if a certain size, for example for some kitchen knives, stainless steel blades are heavy and unwieldy.

Ceramic blades are lighter than steel, have other advantages in cutting food, but are also much more fragile and difficult to sharpen, and they also have a higher average cost than steel blades.

One metal material known and used for its characteristics of lightness, mechanical resistance and machinability is aluminium and its alloys.

Attempts have in fact been made to make cutting blades in aluminium and its alloys; however, such attempts have not been successful primarily due to the fact that aluminium is a soft material and cannot be ground in the traditional way.

The purpose of the present invention is to propose a new method for making a cutting blade in aluminium or its alloys which is effectively able to overcome the limitations of traditional cutting blades, for example in steel or ceramic.

Such purpose is achieved by a method of making a cutting blade according to claim 1 and with a cutting blade according to claim 10.

The characteristics and advantages of the invention will be evident from the description given below, by way of a non-limiting example, of its embodiments, according to the appended drawings. In said drawings:

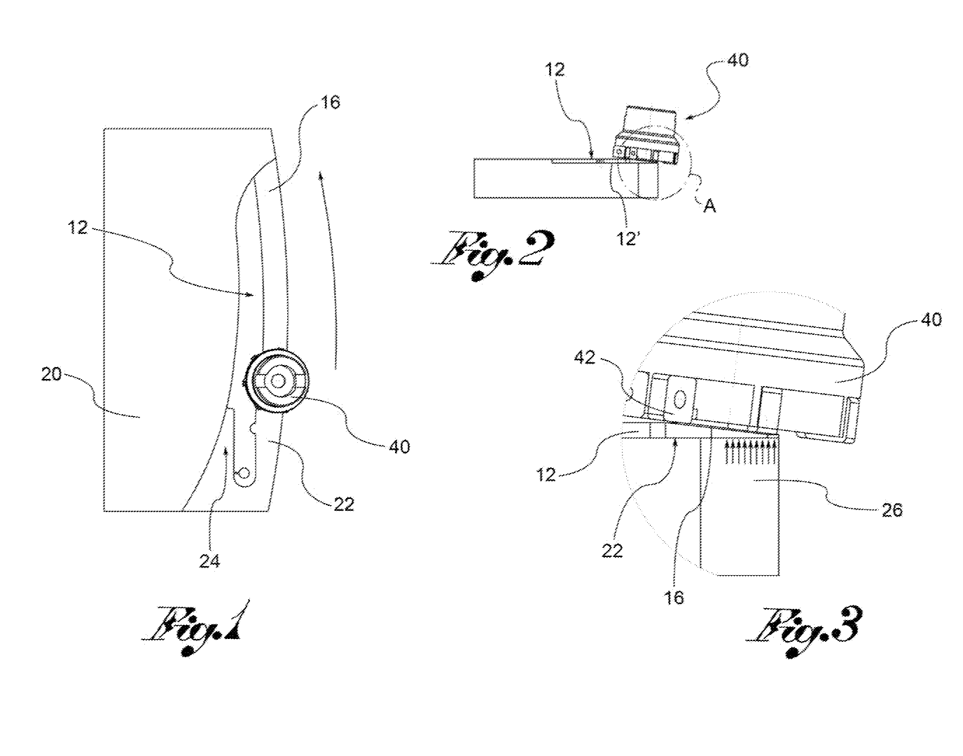

FIG. 1 is a plan view from above of an apparatus during a pre-sharpening step of a cutting blade;

FIG. 2 shows the apparatus in an end view,

FIG. 3 is an enlarged view of the detail A circled in FIG. 2;

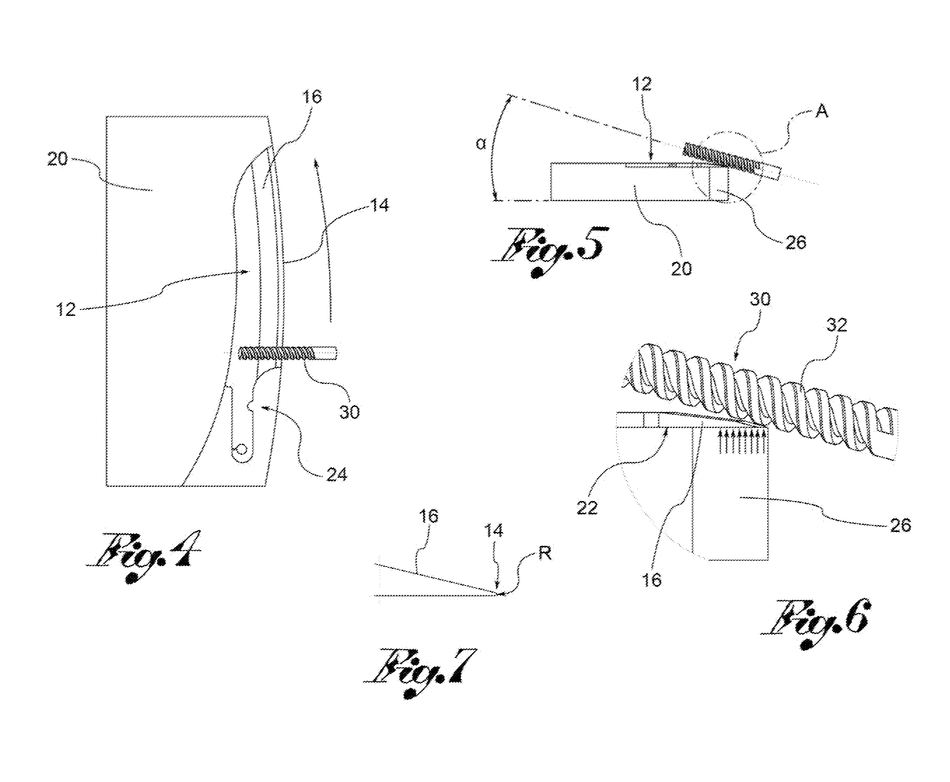

FIG. 4 is a plan view from above of an apparatus during a sharpening step of the cutting blade;

FIG. 5 shows the sharpening apparatus in an end view,

FIG. 6 is an enlarged view of the detail A circled in FIG. 5; and

FIG. 7 shows the profile of the cutting edge of the cutting blade.

A cutting blade in aluminium and its alloys, for example a knife, as shown in the appended drawings, is made starting from a blank 12 of aluminium or its alloys, in the form of a sheet having the desired shape of the cutting blade.

For example, said sheet 12 is obtained by moulding or by cutting, for example laser or water cutting, or by shearing. In order to be properly sharpened, at least one side of the sheet, in the example shown the lower side 12′, should be perfectly flat, as will be described further below.

The sheet 12 is then subjected to a sharpening operation (FIGS. 4-7).

At the end of the sharpening, the blade obtained from the processing of the sheet 12 is subjected to an anodic oxidation process, so as to form at least on the sharpened portion of blade a layer of aluminium oxide (Al₂O₃). Such layer of aluminium oxide gives the blade the necessary characteristics to be effectively used for cutting, in particular hardness, resistance to corrosion, and resistance to abrasive wear.

Returning to the sharpening operation this operation involves the use of a piece-holder equipment 20, for example made of steel, comprising a perfectly planar support surface 22 defining a sheet seat 24 in which the sheet 12 is housed and blocked. For example, said sheet seat 24 is counter-shaped to the shape of the sheet 12. The sheet seat 24 is made along a peripheral portion of the piece-holder equipment 20, so that, when the sheet 12 is positioned on it, the edge 14 of the sheet to be sharpened is facing outward to be worked by the sharpening tool described below.

To sharpen an edge 14 of the sheet 12 a machining tool is used for the removal of shavings for aluminium suitable to reduce the thickness of said edge according to a predetermined sharpening angle in order to obtain a cutting edge.

In a preferred embodiment, said machining tool for the removal of shavings is a sharp cutter 30 for aluminium. Said cutter 30 is made to advance along the peripheral edge 14 of an outer portion 16 of the sheet surface opposite the support surface 22 so as to reduce by removal of the shavings the thickness of said edge 14 according to a predetermined sharpening angle α. Such machining is performed to obtain a cutting edge.

To achieve the correct removal of material from the edge of the sheet it is important that the support surface 22 of the sheet seat 24 contrasts the pressure exerted by the sharp cutter 30 in a uniform manner. To such purpose, the outermost portion of the support surface 22 is made of a metal contrast plate 26, for example of steel. Said metal plate 26 performs the dual function of absorbing the vibrations generated by the cutter and supporting the sheet 12 during machining.

In a preferred embodiment, the sharp cutter 30 is at least a helical rolling cutter 32. With such a cutter, the cutting edge is always engaged on the material. In doing so, it reduces the surface roughness of the edge 14 of the blade. The axis of the helix of the cutting edge with respect to the planar support surface determines the sharpening angle α.

Preferably, the cutting edge 32 of the sharp cutter is coated with polycrystalline diamond or is made from Widia.

During machining, the cutter 30 and the blank 12 are kept cooled by means of a refrigerant-lubricant fluid. It is in fact very important not to overheat the blank in aluminium or its alloys as overheating would cause a tearing of the material. Instead, to get the best surface finish the material must be removed with a clean cut.

As said, the inclination of the sharp cutter 30 determines the sharpening angle of the blade. It is clear that a wider angle is advantageous in terms of impact of the cutter on the sheet, approaching tangency to the lateral surface of the sheet, but produces a blade with a thick sharp edge, and thus with a poor penetration of the material to be cut. Vice versa, a very small sharpening angle makes the cutting edge very thin and therefore very penetrating, but increases the risk of breaking the edge of the sheet during the sharpening operation.

In one advantageous embodiment, to eliminate or reduce the risk of breaking the sheet in the case of a small sharpening angle, the sharp cutter 30 works on the edge 14 of an outer portion 16 of the sheet 12 which already has a thickness that is progressively reduced towards said edge 14, according to a predetermined angle, hereafter defined as the pre-sharpening angle. This way, even though the sharpening angle is very small, the machining affects a very small end portion of the outer portion 16 of the sheet and the risk of breaking said outer portion is virtually eliminated. At the same time, the inclination of the cutting edge given by the pre-sharpening angle, being less than that of the sharpening angle, allows the blade to be very thin and penetrating.

In one embodiment, the thinning of the outer peripheral portion of the sheet 12 which precedes the sharpening operation is obtained by a first machining of the sheet 12, hereafter defined as the pre-sharpening step (FIGS. 1-3).

Such pre-sharpening step uses the same piece-holder equipment 20 described above. After being supported and locked to the planar support surface 22 of the sheet seat 24, an outer portion 16 of the sheet surface opposite the support surface is subjected to machining for the removal of shavings by means of a roughing cutter 40 for aluminium.

In one embodiment, said roughing cutter 40 is a cutter with sintered inserts 42 coated with diamond powder. Unlike the sharp cutter 30, which as said is a cutter of the cylindrical type with a spiral or helical cutting edge, the pre-sharpening cutter 40 is provided with a plurality of inserts 42 which define a work surface as shown in FIG. 3.

In one embodiment variant which provides for making the sheet by moulding, the outer inclined portion 16 of the sheet may be made, completely or partially, in said moulding step.

In one embodiment variant both the sharpening step and the pre-sharpening or roughing step may be performed with a grinding stone which thus removes the shavings by abrasion.

Returning now to the anodic oxidation (or anodizing) process, a typical thickness of the oxide layer which is formed is about 40-60 microns. This oxide layer is formed both below the surface of the sheet and above said surface.

In order to permit an even distribution of the oxide layer, and in particular the formation of said layer on the cutting edge 14, said edge is subjected to a corner rounding operation which, the radius R being to the order of a few μm (FIG. 7) does not affect the sharpening of the blade.

For example, after the sharpening and before the oxidation process, the blade is machined with a diamond cloth which eliminates micro burrs and creates a sufficient rounding on the cutting edge 14 for the formation of the oxide.

In a preferred embodiment, the anodic oxidation process comprises a treatment with silver ions. One such treatment is described for example in EP1207220A1. In practice, the micro porosities of the aluminium oxide are sealed by silver ions. In fact, a silver film is formed on the oxide layer which gives the blade self-lubricating properties, high resistance to corrosion and immunity to bacteria, mildew and lime-scale, the latter characteristics being very advantageous for the application of the blade to kitchen knives.

The present invention also relates, in addition to its method of manufacturing, to a cutting blade comprising a plate-like body in aluminium or its alloys having a flat side 12′ and an opposite side which is connected to said flat side by at least one inclined plane 16. Said flat side and said inclined plane form a sharp edge 14. The sharp edge 14 has a micro-rounded cutting edge, namely with a rounding to the order of a few μm. At least said sharp edge is covered by a layer of aluminium oxide.

Preferably, the layer of aluminium oxide has a total thickness of about 40-60 μm, said layer extending inside and outside the surface of the body in aluminium or alloys thereof.

Preferably, said layer of aluminium oxide is treated with silver ions.

It is to be noted that the cutting blade may be re-sharpened with diamond wheels or discs without removing the layer of aluminium oxide, polishing and restoring the sharp edge of the blade.

A person skilled in the art may make modifications and variations to the embodiments of the method of making a cutting blade according to the invention, replacing elements with others functionally equivalent so as to satisfy contingent requirements while remaining within the sphere of protection of the following claims. Each of the characteristics described as belonging to a possible embodiment may be realised independently of the other embodiments described.

1-14. (canceled)

15. A method of making a cutting blade in aluminium or its alloys, comprising the steps of:
making a sheet in aluminium or its alloys having the shape of the desired cutting blade;
performing a sharpening operation on the blade;
subjecting the blade to an anodising process, so as to form at least on the portion of sharpened blade a layer of aluminium oxide (Al₂O₃),
the sharpening operation comprising the steps of:
laying the sheet on a planar support surface, and
causing a machine tool for removing aluminium shavings to advance along the peripheral edge of an outer portion of the sheet surface opposite the support surface suitable for reducing the thickness of said edge according to a predefined angle of sharpening so as to obtain a cutting edge.

16. The method of claim 15, wherein, before the anodising process, said cutting edge is subjected to a process of micro-rounding suitable for formation of aluminium oxide also on said edge.

17. The method of claim 15, wherein said machine tool for removing shavings is a sharp cutter for aluminium or a grinding stone.

18. The method of claim 17, wherein said sharp cutter is a constant engagement helical rolling sharp cutter, wherein the axis of the helix in relation to the planar support surface determines the angle of sharpening.

19. The method of claim 15, wherein the cutter of the sharp cutter is coated with polycrystalline diamond or made of Widia.

20. The method of claim 15, comprising a pre-sharpening step of the sheet before the sharpening step, wherein an outer portion of the sheet delimited by the peripheral edge to be sharpened is progressively reduced in thickness towards said peripheral edge according to a predefined angle of pre-sharpening.

21. The method of claim 20, wherein said pre-sharpening step comprises the steps of:
laying the sheet on a planar support surface, and
subjecting an outer portion of the surface of the sheet opposite the support surface to machining for the removal of the shaving.

22. The method of claim 21, wherein said machining for the removal of the shaving is performed by a roughing cutter for aluminium or by a grinding stone.

23. The method of claim 22, wherein said roughing cutter is a cutter with sintered inserts coated with diamond powder.

24. The method of claim 15, wherein the sheet is obtained by moulding, laser cutting or shearing.

25. The method of claim 15, wherein the anodising process comprises a sealing step of the micro-porosities of the oxide with silver ions.

26. A cutting blade, comprising a sheet-like body in aluminium or its alloys having one flat side and an opposite side which is connected to said flat side by at least one inclined plane, wherein said flat side and said inclined plane form a sharp edge, said sharp edge having a micro rounded cutting edge, and wherein at least the sharp edge is coated in a layer of aluminium oxide.

27. The cutting blade of claim 26, wherein said layer of aluminium oxide has an overall thickness ranging from 40 to 60 μm, said layer extending inside and outside the surface of the body in aluminium or its alloys.

28. The cutting blade of claim 26, wherein said layer of aluminium oxide is treated with silver ions.
